(19) United States
(12) Patent Application Publication
(10) Pub. No.: US 2026/0028184 A1
(43) Pub. Date: Jan. 29, 2026

(54) Chainless lifting and reversing mechanism for a four-way shuttle

(71) Applicant: Bullseye Intelligent Logistics Equipment (Suzhou) Co., Ltd., Suzhou (CN)

(72) Inventors: Jian Shen, Suzhou (CN); Libin Kuai, Suzhou (CN); Youcai Shen, Suzhou (CN); Xiangming Wang, Suzhou (CN); Linhua Chen, Suzhou (CN)

(21) Appl. No.: 19/174,688

(22) Filed: Apr. 9, 2025

(30) Foreign Application Priority Data
Jul. 25, 2024 (CN) 202421769012.6

(51) Int. Cl. B65G 1/04

(52) U.S. Cl. CPC B65G 1/0492

(57) ABSTRACT

A chainless lifting and reversing mechanism for a four-way shuttle, comprising a first lifting and reversing gearbox; a planetary reducer, a servo motor, a first rotating shaft, a power gear, a transmission gear, a driven gear, and a second rotating shaft, a transmission shaft, a second lifting and reversing gearbox, a mounting plate, a cam, a sliding block, a sliding groove. An X-direction travel gearbox is provided with a guide groove, which is further provided with X-direction travel wheels. The guide groove controls the stability of X-direction travel wheels, preventing the four-way shuttle from falling due to the partial overload while changing direction.

### FIELD OF THE INVENTION

The present invention relates generally to warehousing logistics equipment, and more specifically, it relates to a chainless lifting and reversing mechanism that increases the efficiency of a four-way shuttle.

### DESCRIPTION OF THE RELATED ART

Any discussion of the prior art throughout the specification should in no way be considered as an admission that such prior art is widely known or forms part of common general knowledge in the field.

In intensive storage scenarios, the shelves or floors are relatively high, and the entry and exit locations are generally on the ground floor. A four-way shuttle is needed to go to the high-rise floor-changing elevator and pick up and place goods on each upper shelf or floor to complete the entry or exit of goods in the high-rise storage locations.

Publication No. CN112978181A discloses a four-way shuttle, including: a controller; a sensor electrically connected to the controller; a hydraulic pump assembly, including a hydraulic pump drive motor electrically connected to the controller; a hydraulic valve assembly connected to the hydraulic pump assembly; a reversing hydraulic cylinder connected to the hydraulic valve assembly; a reversing bracket mechanically connected to the plunger rod of the reversing hydraulic cylinder; a travel drive motor electrically connected to the controller; a reducer mechanically connected to the travel drive motor, having a first drive component and a second drive component; a travel drive assembly in the direction of a child vehicle, mechanically connected to the first drive component; a travel drive assembly in the direction of a parent vehicle, mechanically connected to the second drive component. The prior disclosure is provided with a hydraulic reversing and lifting and device, which reduces the intermediate transmission links, has a lower failure rate, is more convenient to install and maintain, and greatly reduces the operating noise of the four-way shuttle vehicle.

However, the disclosure has the following problems in actual use: due to network communication signals and software program loopholes, problems may occur in the lifting of the hydraulic cylinder, resulting in asynchronous lifting of the reversing hydraulic cylinder. In addition, the chain stretching caused by the chain drive in the prior disclosure leads to looseness and inaccurate wheel starting and stopping, which can easily lead to overloading of the mechanism when the four-way shuttle is reversing, causing it to fall or deflect, thereby causing economic losses and casualties.

### BRIEF SUMMARY OF THE INVENTION

In view of the foregoing disadvantages inherent in the previous disclosure, the present invention provides a chainless lifting and reversing mechanism in a four-way shuttle.

The chainless lifting and reversing mechanism in a four-way shuttle generally comprises a first lifting and reversing gearbox, a planetary reducer, a servo motor, a first rotating shaft, a power gear, a transmission gear, a driven gear, a second rotating shaft, a transmission shaft, a second lifting and reversing gearbox, a mounting plate.

The shuttle further comprises a cam, a sliding block, a sliding groove, and an X-direction travel gearbox.

The shuttle further comprises a guide groove, a guide block, and X-direction travel wheels.

Preferably, the first lifting and reversing gearbox is rotatably connected to the first rotating shaft; the first rotating shaft is fixedly connected to the power gear; the power gear is meshed with the transmission gear; the transmission gear is meshed with the driven gear; the driven gear is fixedly connected to the second rotating shaft; the second rotating shaft is fixedly connected to the transmission shaft; the transmission shaft is rotatably connected to the second lifting and reversing gearbox; and the second rotating shaft is rotatably connected to the mounting plate to provide power for the cam.

Preferably, the cam is rotatably connected to the sliding block; the sliding block is slidingly connected to the sliding groove; and the sliding groove is fixedly connected to the X-direction travel gearbox.

Preferably, the guide groove is slidingly connected to the guide block, and the X-direction travel gearbox is rotatably connected to the X-direction travel wheels, which facilitates the sliding of the X-direction travel gearbox on the lifting and reversing gearbox.

Preferably, the first rotating shaft passes through the first lifting and reversing gearbox and is fixedly connected to the planetary reducer; the mounting plate is fixedly connected to the first lifting and reversing gearbox; and the transmission shaft is fixedly connected to the second rotating shaft to facilitate the provision of power for the second rotating shaft.

Preferably, the cam is fixedly connected to the second rotating shaft; the transmission gear is rotatably connected to the mounting plate; and the second rotating shaft passes through the mounting plate and is fixedly connected to the transmission shaft to facilitate the simultaneous rotation of the cam.

Preferably, the guide block is fixedly connected to the first lifting and reversing gearbox, and the guide groove is slidingly connected to the guide block to facilitate the sliding of the X-direction travel gearbox on the outer side of the first lifting and reversing gearbox.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

Compared with the prior disclosure, the present disclosure has the following advantages. First, the chainless lifting and reversing mechanism of the four-way shuttle, through the first rotation shaft, the power gear, the transmission gear, the driven gear, the second rotation shaft, the mounting plate, the cam, the sliding block and the sliding groove, controls the stability of the X-direction travel wheels and prevents the four-way shuttle from falling or deflecting due to overload caused by reversal, and further prevents economic losses and casualties of accidents and makes the four-way shuttle safer. Second, the X-direction travel wheels can be stably raised and lowered with the planetary reducer, the cam and the transmission shaft, thereby preventing problems with the hydraulic cylinder raising and lowering caused by network communication signals and software program loopholes, and eliminating looseness caused by chain stretching caused by chain drive and inaccurate wheel starting and stopping; it further eliminates the looseness caused by the chain stretching caused by the chain drive and the inaccurate start and stop of the wheel, thereby improving the stability of the four-way shuttle.

To the accomplishment of the above and related advantages, this disclosure may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an overall structure of the present invention.

FIG. 2 is an expansion structure of the present invention.

FIG. 3 is a contracting structure of the present invention.

FIG. 4 is a perspective view of the first lifting and reversing gearbox.

FIG. 5 is a front view of the mounting plate.

FIG. 6 is a front view of the X-direction traveling gearbox.

### DETAILED DESCRIPTION OF THE INVENTION

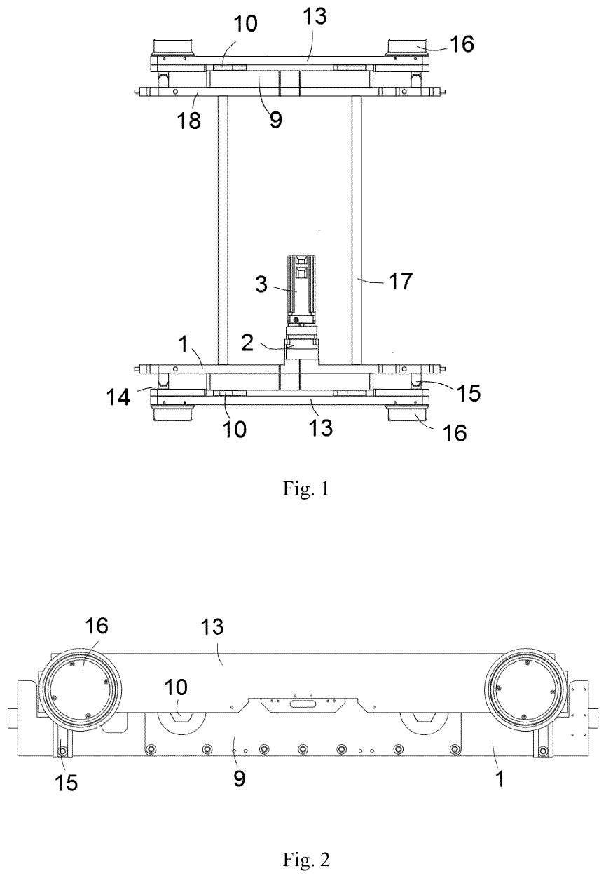

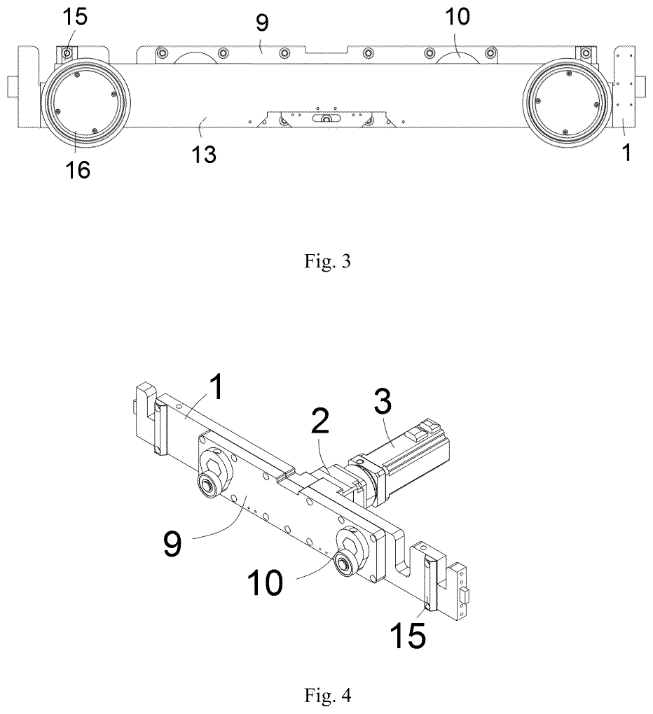

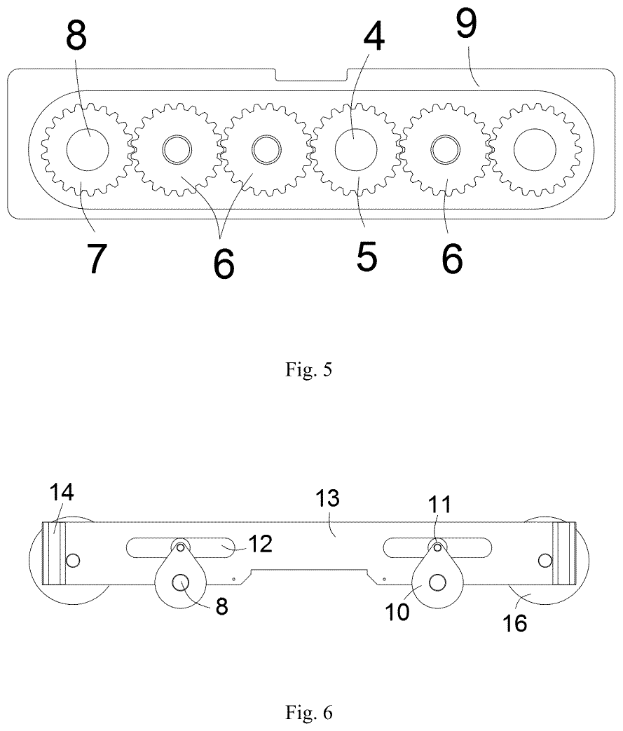

Turning now descriptively to the drawings, in which similar reference characters denote similar elements throughout the several view, FIGS. 1 through 6 illustrate a chainless lifting and reversing mechanism of a four-way shuttle, which comprises a first lifting and reversing gearbox 1, a planetary reducer 2 on a side of the first lifting and reversing gearbox 1, and a servo motor 3 on a side of the planetary reducer 2; it further comprises a first rotating shaft 4 on another side of the first lifting and reversing gearbox 1; a power gear 5 on a side of the first rotating shaft 4; a transmission gear 6 on a side of the power gear 5; a driven gear 7 on a side of the transmission gear 6; a second rotating shaft 8 on a side of the driven gear 7; a transmission shaft 17 on a side of the second rotating shaft 8; a second lifting and reversing gearbox 18 on a side of the transmission shaft 17; a mounting plate 9 on another side of the second rotating shaft 8, and a cam 10 on one side of the mounting plate 9. The first lifting and reversing gearbox 1 is rotatably connected to the first rotating shaft 4; the first rotating shaft 4 is fixedly connected to the power gear 5; the power gear 5 is meshed connected with the transmission gear 6; the transmission gear 6 is meshed connected with the driven gear 7; the driven gear 7 is fixedly connected to the second rotating shaft 8; the second rotating shaft 8 is fixedly connected to the transmission shaft 17; the transmission shaft 17 is rotatably connected to the second lifting and reversing gearbox 18; and the second rotating shaft is rotatably connected to the mounting plate 9. The first rotating shaft 4 passes through the first lifting and reversing gearbox 1 and fixedly connected to the planetary reducer 2; the mounting plate 9 is fixedly connected to the first lifting and reversing gearbox 1; and the transmission shaft 17 is connected to the second rotating shaft 8 on one side of the second lifting and reversing gearbox 18. As shown in FIGS. 1 and 4 through 6, the power gear 5 is driven to rotate by the first rotating shaft 4, and there are three groups of transmission gears 6. The power gear 5 drives the driven gear 7 to rotate through the meshing of two groups of transmission gears 6. The power gear 5 also drives the driven gear 7 to rotate through one group of transmission gear 6, so that the driven gear 7 drives the second rotating shaft 8 to rotate, thereby providing power for the cam 10, so that the cam 10 is evenly swung and stressed and its life span is extended. Also, it provides power to the rotating shaft 8 on one side of the mounting plate 9 through the transmission shaft 17, so as to facilitate the simultaneous rotation of the second rotating shaft 8, thereby improving the stability of the rotation of the cam 10.

The chainless lifting and reversing mechanism of a four-way shuttle, further comprises a cam 10 on a side of the mounting plate 9; a sliding block 11 on a side of the cam 10; a sliding groove 12 on a side of the sliding block 11; an X-direction travel gearbox 13 on a side of the sliding groove 12; the cam 10 is fixedly connected to the second rotating shaft 8, and the second rotating shaft 8 passes through the mounting plate 9 and fixedly connected to the transmission shaft 7. As shown in FIGS. 1 and 4 through 6, the cam 10 is driven to rotate simultaneously by the second rotating shaft 8, and the two sides of the X-direction travel gearbox 13 are lifted and lowered simultaneously, so as to prevent the four-way shuttle from falling or deflecting due to overload when changing direction, and to further prevent the occurrence of economic losses and casualties.

The chainless lifting and reversing mechanism of a four-way shuttle, further comprises a guide groove 14 on a side of the X-direction travel gearbox 13; a guide block 15 on a side of the guide groove 14; and X-direction travel wheels 16 on another side of the X-direction travel gearbox 13. The guide block 15 is fixedly connected to the first lifting and reversing gearbox 1, and the guide groove 14 on one side of the X-direction travel gearbox 13 is slidingly connected to the guide block 15 on one side of the first lifting and reversing gearbox 1. As shown in FIGS. 1 through 3, the guide groove 14 and the guide block 15 facilitate the X-direction travel gearbox 13 to slide on a side of the first lifting and reversing gearbox 1 and the second lifting and reversing gearbox 18, so that the movement of the X-direction travel gearbox 13 on the first lifting and reversing gearbox 1 is more stable, eliminating the hydraulic cylinder lifting and lowering problems caused by the network communication signal, software program loopholes, and the looseness caused by the chain stretching caused by the chain drive and the inaccurate wheel start and stop.

An operation method of the chainless lifting and reversing mechanism is:

First, turn on the power supply of the servo motor 3, so that the servo motor 3 drives the planetary reducer 2 to start, thereby rotating the first rotating shaft 4 on one side of the first lifting and reversing gearbox.

Second, the first rotating shaft 4 drives the power gear 5 to rotate, and the power gear 5 drives the transmission gear 6 to rotate on the mounting plate 9, and then the transmission gear 6 drives the driven gear 7 to rotate, the second rotating shaft 8 rotates on the mounting plate 9 and slides through the sliding block 11 at one end of the cam 10 in the sliding groove 12, At the same time, one side of the second rotating shaft 8 drives the rotating shaft 8 on one side of the second lifting and reversing gearbox 18 to rotate through the drive shaft 17.

Finally, the X-direction travel gearbox 13 slides on the guide block 15 on one side the lifting and reversing gearbox 1 through the guide groove 14, thereby controlling the lifting of the X-direction travel wheels 16.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A chainless lifting and reversing mechanism for a four-way shuttle, comprising a first lifting and reversing gearbox, a planetary reducer, a servo motor, a first rotating shaft, a power gear, a transmission gear, a driven gear, a second rotating shaft, a transmission shaft, a second lifting and reversing gearbox, a mounting plate, a cam, a sliding block, a sliding groove, an X-direction travel gearbox, a guide groove, a guide block, and X-direction travel wheels.

2. The chainless lifting and reversing mechanism for a four-way shuttle in claim 1, wherein the first lifting and reversing gearbox is rotatably connected to the first rotating shaft; the first rotating shaft is fixedly connected to the power gear; the power gear is meshed with the transmission gear; the transmission gear is meshed with the driven gear; the driven gear is fixedly connected to the second rotating shaft; the second rotating shaft is fixedly connected to the transmission shaft; the transmission shaft is rotatably connected to the second lifting and reversing gearbox; and the second rotating shaft is rotatably connected to the mounting plate.

3. The chainless lifting and reversing mechanism for a four-way shuttle in claim 1, wherein the cam is rotatably connected to the sliding block; the sliding block is slidingly connected to the sliding groove; and the sliding groove is fixedly connected to the X-direction travel gearbox.

4. The chainless lifting and reversing mechanism for a four-way shuttle in claim 1, wherein the guide groove is slidingly connected to the guide block, and the X-direction travel gearbox is rotatably connected to the X-direction travel wheels.

5. The chainless lifting and reversing mechanism for a four-way shuttle in claim 2, wherein the first rotating shaft passes through the first lifting and reversing gearbox and is fixedly connected to the planetary reducer; the mounting plate is fixedly connected to the first lifting and reversing gearbox; and the transmission shaft is fixedly connected to the second rotating shaft.

6. The chainless lifting and reversing mechanism for a four-way shuttle in claim 3, wherein the cam is fixedly connected to the second rotating shaft; the transmission gear is rotatably connected to the mounting plate; and the second rotating shaft passes through the mounting plate and is fixedly connected to the driving gear.

7. The chainless lifting and reversing mechanism for a four-way shuttle in claim 4, wherein the guide block is fixedly connected to the first lifting and reversing gearbox, and the guide groove is slidably connected to the guide block.
